(19) United States
(12) Patent Application Publication
(10) Pub. No.: US 2003/0004835 A1
(43) Pub. Date: Jan. 2, 2003

(54) Method, system, and product service for locating items satisfying a general requirement and ranking items according to utility

(75) Inventors: William Grey, Millwood, NY (US); Samuel H. Dinkin, Austin, TX (US); Paul A. Moskowitz:, Yorktown Heights, NY (US); Philip S. Yu, Chappagua, NY (US); Stephen J. Boies, Mahopac, NY (US); David P. Greene, Ossining, NY (US)

Correspondence Address: Duke W. Yee, Carstens, Yee & Cahoon. LLP, P.O. Box 802334, Dallas, TX, 75380, US

(73) Assignee: International Business Machines Corporation, Armonk, NY (US)

(21) Appl. No.: 09/871,041

(22) Filed: May 31, 2001

(51) Int. Cl. G06F 17/60

(52) U.S. Cl. 705/27

(57) ABSTRACT

A method, system, and product are described for locating items which satisfy a general requirement and then ranking those items according to the utility of each type of item. A general requirement is first received. A utility is specified for each of multiple types of items which would satisfy the general requirement. Available items are then located which match one of the specified types of items. The located available items are then ranked utilizing the utility specified for the types of items.

### BACKGROUND OF THE INVENTION

1. Technical Field

The present invention relates generally to a method, system, and product for ranking available items according to the utility of each type of item. Still more particularly, the present invention relates to a method, system, and product in a computer system for a service which locates items which satisfy a general requirement and ranks those items according to the utility of each type of item.

2. Description of Related Art

Intelligent shopping agents are known in the art. These agents typically execute on a client computer system and are used to search a server computer system or other client computer systems for a particular, specified item which may be either goods or services. A user first specifies a particular type of item. A user may specify, for example, a dishwasher. The intelligent agent then searches for and returns a list of available items which match the specified type of item. Therefore, a list of available dishwashers may be returned by the intelligent agent. The user may then select one or more of these available items.

Often times, multiple different items may satisfy a particular user's needs. For example, a user may need to purchase a car. There are many different types of cars which could be purchased to satisfy this requirement. A user may place a higher value, or utility, on one attribute over another. For example, one user may place a higher value on an intangible attribute, such as status, over the price of a car. The intelligent shopping agent has no way to locate items based on a user's desires. The intelligent shopping agent merely searches for specified items.

As a further example of the limitations of known shopping agents, consider a user who requires transportation but does not require any particular type of transportation means. The user's requirement could be satisfied by buying a bicycle, a motorcycle, a car, or a helicopter. A known intelligent agent could be used to search first for bicycles returning a listing of bicycles. Then, the agent could be used to search for motorcycles, returning a listing of motorcycles. The agent could then be used to search for cars returning a listing of cars. And, the agent could be used to search for helicopters.

The user must then compare the separate listings returned for each type of transportation means in order to select a particular item. Each user will make a selection based on that user's preferences. Each user will place different values on the various attributes of each transportation means in order to make a selection. For example, one user may value ease-of-use and maintenance over status and thus place a greater value on a bicycle over the helicopter. Therefore, a high quality bicycle would be ranked higher than a helicopter. A different user might value status over everything but have limited funds to make a purchase. For this user, cars perceived to have a higher associated status might be ranked first.

Therefore, a need exists for a system, method, and product in a computer system for a service which searches for items which would satisfy a general requirement and which ranks these items according to the utility of each type of item.

### SUMMARY OF THE INVENTION

A method, system, and product are described for locating items which satisfy a general requirement and then ranking those items according to the utility of each type of item. A general requirement is first received. A utility is specified for each of multiple types of items which would satisfy the general requirement. Available items are then located which match one of the specified types of items. The located available items are then ranked utilizing the utility specified for the types of items.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a data processing system in which the present invention may be implemented;

FIG. 2 illustrates a block diagram of a computer system which may be utilized as a server computer system in accordance with the present invention;

FIG. 3 depicts a block diagram of a computer system which may be utilized as a client computer system in accordance with the present invention; and

FIG. 4 is a high level flow chart which depicts a specification of a requirement and a utility for different types of items in accordance with the present invention; and

FIG. 5 is a high level flow chart which illustrates an intelligent software agent searching for and locating available items which match a specified type of items and ranking the located items according to the items' utility in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The invention is preferably realized using a well-known computing platform, such as an IBM RS/6000 server running the IBM AIX operating system. However, it may be realized in other popular computer system platforms, such as an IBM personal computer running the Microsoft Windows operating system or a Sun Microsystems workstation running operating systems such as UNIX or LINUX, without departing from the spirit and scope of the invention.

The present invention is a method, system, and product within a computer system for locating items which satisfy a general requirement and then ranking those items according to the utility specified for each type of item by a user. Preferably, the present invention is implemented utilizing an intelligent agent, although other software services or code may be utilized.

A general requirement is first received by the intelligent agent. The general requirement may be very broad including many different types of categories of items. For example, the requirement may be for a means of transportation which would include the categories of bicycles, cars, airplanes, helicopters, and other types of transportation.

A utility is then specified for each type of item which would satisfy the general requirement. Typically, the utility will be specified by a user who has the general requirement.

The intelligent agent then searches for items which are available which would satisfy the requirement. Available items are located by the intelligent agent. The intelligent agent compares the price for each located available item to the utility for that type of item and then ranks the located available items according to this comparison.

In one embodiment, the intelligent agent determines a utility to price ratio for each located item. The ratio is determined utilizing the price of an available item and the utility specified for that type of item. The intelligent agent then ranks the located items according to the ratio determined for each available item.

Once the available items are ranked, they may be displayed to a user who then may select one of the items. Alternatively, the intelligent agent may be empowered to automatically complete a purchase of the one item which is ranked as having the best utility to price comparison once that item is found.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

Clients 108, 110, and 112 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network.

In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

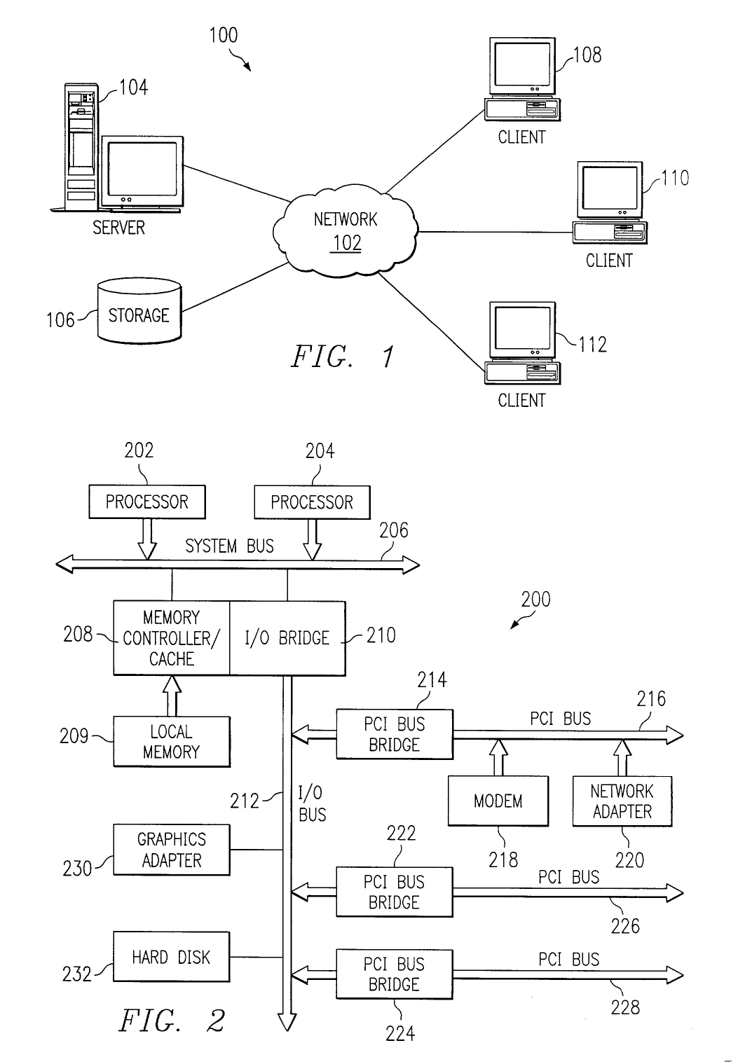

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

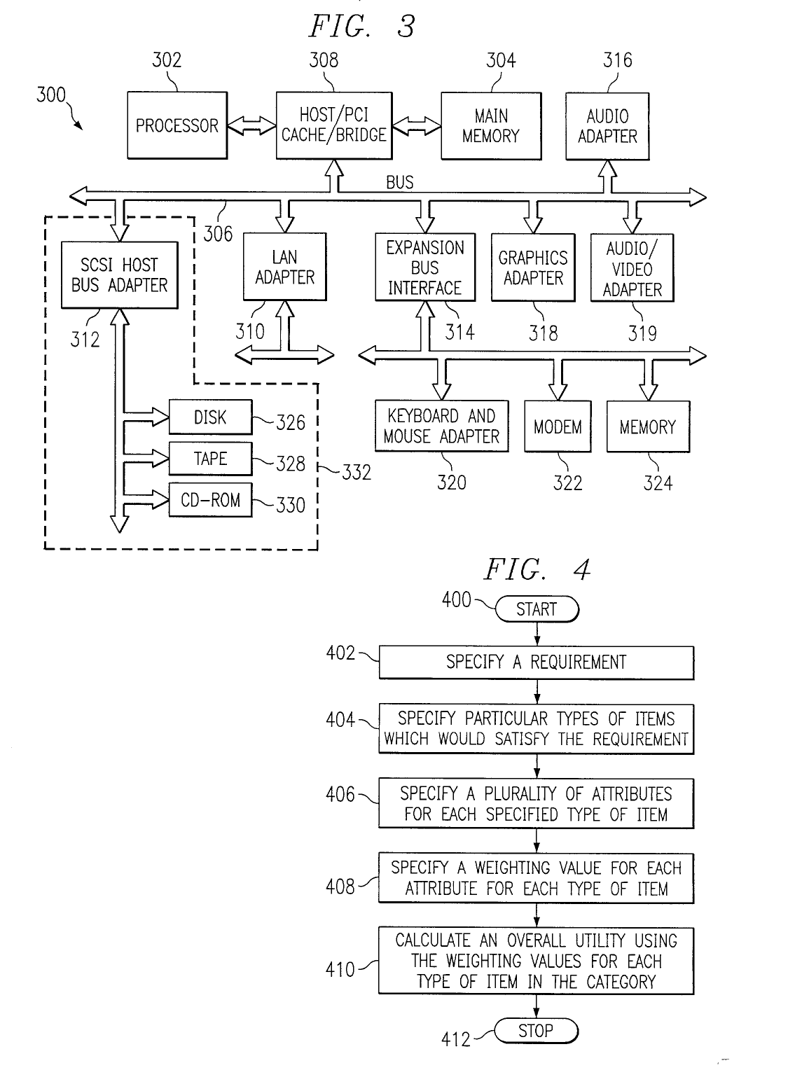

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a high level flow chart which depicts a specification of a utility for different types of items in accordance with the present invention. The process starts as depicted by block 400 and thereafter passes to block 402 which illustrates the specification of a general requirement. A user may specify a general requirement, for example, of some means of transportation. Next, block 404 depicts a specification of particular types of items which would satisfy the requirement. In this example, a bicycle, a motorcycle, or a car would satisfy this general requirement. Thereafter, block 406 illustrates a specification of a plurality of attributes for the items. Continuing with the transportation example, attributes such as color, body style, ease-of-use, difficulty of maintaining, price, and other attributes may be specified. Thereafter, block 408 illustrates a specification of a weighting value for each attribute for each type of item which would satisfy the requirement. Ease-of-use may be valued more highly by some users over price. For other users, status may be valued more highly over price. Block 410, then, depicts a calculation of an overall utility using the weighting values for each attribute for each type of item which would satisfy the requirement. The process then terminates as illustrated by block 412.

The following is a simplified example of the present invention. Suppose three people are each interested in purchasing a car. Utility information is first elicited from each person as shown below.

| | Person 1 | Person 2 | Person 3 |
|---|---|---|---|
| Prestige | 80 | 0 | 0 |
| Reliability | 20 | 180 | 20 |
| Economy | 0 | 20 | 80 |
| TOTAL | 100 | 200 | 100 |

Utility weighting values are then calculated for each person for each attribute as shown below by dividing the utility by the total. Any other suitable method for calculating weighting values may be utilized.

| | Person 1 | Person 2 | Person 3 |
|---|---|---|---|
| Prestige | 0.8 | 0 | 0 |
| Reliability | 0.2 | 0.9 | 0.2 |
| Economy | 0 | 0.1 | 0.8 |

Further suppose that three different cars have been assigned the following ratings for the three attributes of interest to these potential buyers, prestige, reliability, and economy. Some of these rankings are very subjective and may be entered by each person. For example, each person could enter the prestige rankings. Other rankings, such as reliability may be more objective and could be obtained from some third party source. Still other rankings might be computed by the present invention. For example, a cost of ownership could be calculated by the present invention if lifetime maintenance costs, fuel consumption, resale, and other information is provided.

| | Car 1 | Car 2 | Car 3 |
|---|---|---|---|
| Prestige | 90 | 20 | 0 |
| Reliability | 80 | 99 | 70 |
| Economy | 20 | 40 | 99 |

The present invention then calculates a value for each person for each attribute by multiplying the weighting value for an attribute and the rating for that attribute. The following values are thus determined for Car 1.

| | Person 1 | Person 2 | Person 3 |
|---|---|---|---|
| Prestige | 90 × 0.8 = 72 | 90 × 0 = 0 | 90 × 0 = 0 |
| Reliability | 80 × 0.2 = 16 | 80 × 0.9 = 72 | 80 × 0.2 = 16 |
| Economy | 20 × 0 = 0 | 20 × 0.1 = 2 | 20 × 0.8 = 16 |
| TOTAL | 88 | 74 | 32 |

Similar calculations are made for Car 2.

| | Person 1 | Person 2 | Person 3 |
|---|---|---|---|
| Prestige | 16 | 0 | 0 |
| Reliability | 19.8 | 89.1 | 19.8 |
| Economy | 0 | 4 | 32 |
| TOTAL | 35.8 | 93.1 | 51.8 |

The following are the values for Car 3.

| | Person 1 | Person 2 | Person 3 |
|---|---|---|---|
| Prestige | 0 | 0 | 0 |
| Reliability | 14 | 63 | 14 |
| Economy | 0 | 9.9 | 79.2 |
| TOTAL | 14 | 72.9 | 93.2 |

A utility matrix having the total utility for each person for each car is created by taking the numbers from the calculations completed above.

| | Person 1 | Person 2 | Person 3 |
|---|---|---|---|
| Car 1 | 88 | 74 | 32 |
| Car 2 | 35.8 | 93.1 | 51.8 |
| Car 3 | 14 | 72.9 | 93.2 |

The present invention then searches for available cars matching Car 1, Car 2, and Car 3 and locates those having the best price. Suppose the following available cars were found.

| | Price |
|---|---|
| Car 1 | $35,000 |
| Car 2 | $20,000 |
| Car 3 | $16,000 |

A comparison is then made between each car and the total utility from the utility matrix. For the comparison calculation shown below, the price was divided by the total utility.

| | Person 1 | Person 2 | Person 3 |
|---|---|---|---|
| Car 1 | 397.73 | 472.97 | 1,093.75 |
| Car 2 | 558.66 | 214.82 | 386.1 |
| Car 3 | 1,142.86 | 219.48 | 171.67 |

The car which maximizes the utility for each person, in this case the car having the lowest number, is then selected. Therefore, Car 1 is selected for Person 1. Car 2 is selected for Person 2. And, Car 3 is selected for Person 3.

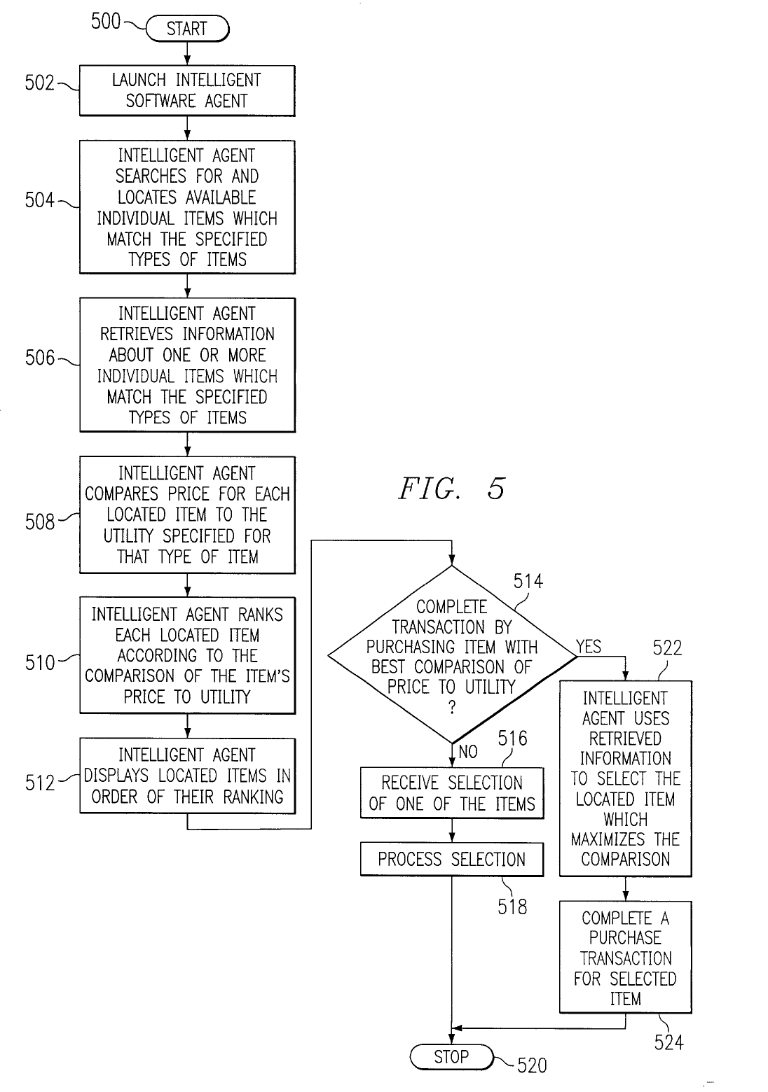

FIG. 5 is a high level flow chart which depicts an intelligent software agent searching for and locating available items which match a specified type of items and ranking the located items according to the items' utility in accordance with the present invention. The process starts as depicted by block 500 and thereafter passes to block 502 which illustrates the launching of an intelligent software agent. Those skilled in the art will recognize that other software services, utilities, or code may be utilized instead of an intelligent software agent to implement the present invention.

Next, block 504 depicts the intelligent agent searching for and locating individual items which are available to be purchased which match the specified types of items which would satisfy the requirement. The process then passes to block 506 which illustrates the intelligent agent retrieving information about one or more individual items which match the specified types of items. Thereafter, block 508 depicts the intelligent agent comparing the price for each located item to the utility specified for that type of item. Block 510, then, illustrates the intelligent agent ranking each located item according to the comparison of the item's price to that type of item's utility. One method for comparing the price to utility is to calculate a ratio of the price to the utility. Another v method for making such a comparison is to calculate the difference between the utility and the price. As yet another method to make a comparison, a user could specify a minimum utility. Thereafter, the lowest priced available item which meets or exceeds this minimum utility would be ranked as maximizing the user's utility. Any other method for making a comparison may be utilized. The process then passes to block 512 which depicts the intelligent agent displaying these located items in order of their ranking, preferably from the item having the best comparison to the item having the worst comparison.

Next, block 514 illustrates a determination of whether or not the intelligent agent is to complete the transaction by purchasing the item with the best comparison of price to utility, i.e. the individual item which maximizes utility. If a determination is made that the intelligent agent is not to complete the transaction by purchasing the item, the process passes to block 516 which depicts receiving a selection from a user of one of the items. Thereafter, block 518 illustrates processing the selection according to instructions received from a user. The process then terminates as depicted by block 520. Referring again to block 514, if a determination is made that the intelligent agent is to complete the transaction by purchasing the item, the process passes to block 522 which depicts the intelligent agent using the information retrieved about the items which matched the specified types of items to select the located item which maximizes the comparison. Next, block 524 illustrates the intelligent agent completing a purchase transaction for the selected item. The process then terminates as depicted by block 520.

The description of the form of the utility function described in the preferred embodiment of the present invention has been presented for purposes of illustration and description, but is not intended to be exhaustive or limited to the invention in the form disclosed. Many modifications and variations will be apparent to those of ordinary skill in the art. We have described a simple way to build a utility function that determines a degree of utility by aggregating multiple criteria into a single function. However utility functions can take many forms, and utility can be elicited in a number of ways. Forms include, for example, the linear additive, non-linear multiplicative, and multi-linear form. There are other approaches for specifying and eliciting utility known to those skilled in the art, such as the Analytic Heirarchy Process, which comprises hierarchically decompose the problem to make the multi-attribute utility analysis more tractable. This approach calls for breaking down the highest-level goal into sub-goals, which can then be further broken down into sub-goals, and then sub-sub-goals, until measurable utility criteria can be determined. Weights to the criteria can then be determined in a number of ways, including pair-wise comparisons along dimensions such as ordinality, cardinality, or ranking along a linguistic scale.

Other approaches besides the utility function approach can be used, such as the out-ranking approach, which involves determining a relation which contains the preferences of each alternative over all the other alternatives, and is thus somewhat richer than the utility function approach. Other approaches, such as the lexicographic approach, use an ordered set of preference classes defined across attributes and their levels. Fuzzy logic approaches can be used as well, including use of fuzzy utility, fuzzy out-ranking, fuzzy inference, fuzzy control, or the fuzzy analytical hierarchical process. All these approaches for eliciting and modeling utility, and for performing multi-attribute utility analysis, and others known to those skilled in the art, are applicable to the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a computer system, said method comprising the steps of:
receiving a general requirement;
receiving a specified utility for at least one of a plurality of types of items which would satisfy said requirement;
locating a plurality of available items which match at least one of said plurality of types of items; and
ranking said located plurality of available items utilizing said utility specified for at least one of said plurality of types of items.

2. The method according to claim 1, further comprising the steps of:
providing an intelligent software agent;
receiving, utilizing said intelligent software agent, a general requirement;
receiving, utilizing said intelligent software agent, a specified utility for each of a plurality of types of items which would satisfy said requirement;
locating, utilizing said intelligent software agent, a plurality of available items which match one of said plurality of types of items; and
ranking, utilizing said intelligent software agent, said located plurality of available items utilizing said utility specified for each of said plurality of types of items.

3. The method according to claim 2, further comprising the step of providing said intelligent software agent executing within a client computer system, said client computer system being coupled to a server computer utilizing a computer network.

4. The method according to claim 3, further comprising the step of coupling said client computer system to said server computer system utilizing an Internet computer network.

5. The method according to claim 1, further comprising the steps of:
coupling a server computer system to a plurality of client computer systems;
providing an intelligent software agent executing within one of said plurality of client computer systems; and
searching, utilizing said intelligent agent, said plurality of client computer systems for said plurality of available items which match one of said plurality of types of items.

6. The method according to claim 1, wherein the step of ranking further comprises the step of comparing a price for each of said plurality of available items to a utility for one of said plurality of types of items which matches said each of said plurality of available items.

7. The method according to claim 6, wherein the step of comparing further comprises the step of determining a difference between said price for each of said plurality of available items and said utility for one of said plurality of types of items which matches said each of said plurality of available items.

8. The method according to claim 6, wherein the step of comparing further comprises the step of determining a ratio of said price for each of said plurality of available items to said utility for one of said plurality of types of items which matches said each of said plurality of available items.

9. The method according to claim 1, further comprising the steps of:
setting a utility threshold; and
locating a second plurality of available items which match one of said plurality of types of items and which exceed said utility threshold.

10. The method according to claim 9, further comprising the step of selecting one of said second plurality of available items having a lowest price.

11. The method according to claim 1, further comprising the step of displaying said located plurality of available items.

12. The method according to claim 1, further comprising the step of selecting one of said located plurality of available items.

13. The method according to claim 1, further comprising the steps of:
selecting, utilizing an intelligent agent, one of said located plurality of available items; and
completing a purchase transaction, utilizing said intelligent agent, to purchase said selected one of said located plurality of items.

14. The method according to claim 13, further comprising the step of determining a ratio of a price for each of said plurality of available items to said utility for one of said plurality of types of items which matches said each of said plurality of available items.

15. The method according to claim 14, further comprising the step of selecting one of said located plurality of available items which provides a highest ratio.

16. The method according to claim 1, further comprising the step of receiving said plurality of types of items specified by a user.

17. The method according to claim 1, further comprising the step of receiving said plurality of types of items specified by executing a table lookup.

18. The method according to claim 1, further comprising the step of receiving said utility for each of said plurality of types of items specified by a user.

19. The method according to claim 1, further comprising the steps of:
receiving a plurality of attributes for each of said specified plurality of types of items;
receiving a weighting value specified for each of said plurality of attributes; and
determining an overall utility for each of said plurality of types of items utilizing said weighting value specified for each of said plurality of attributes.

20. A computer program product in a computer system, comprising:
instruction means for receiving a general requirement;
instruction means for receiving a specified utility for at least one of a plurality of types of items which would satisfy said requirement;
instruction means for locating a plurality of available items which match at least one of said plurality of types of items; and
instruction means for ranking said located plurality of available items utilizing said utility specified for at least one of said plurality of types of items.

21. The product according to claim 20, further comprising:
instruction means for providing an intelligent software agent;
instruction means for receiving, utilizing said intelligent software agent, a general requirement;
instruction means for receiving, utilizing said intelligent software agent, a specified utility for each of a plurality of types of items which would satisfy said requirement;
instruction means for locating, utilizing said intelligent software agent, a plurality of available items which match one of said plurality of types of items; and
instruction means for ranking, utilizing said intelligent software agent, said located plurality of available items utilizing said utility specified for each of said plurality of types of items.

22. The product according to claim 21, further comprising instruction means for providing said intelligent software agent executing within a client computer system, said client computer system being coupled to a server computer utilizing a computer network.

23. The product according to claim 22, further comprising instruction means for coupling said client computer system to said server computer system utilizing an Internet computer network.

24. The product according to claim 20, further comprising:
instruction means for coupling a server computer system to a plurality of client computer systems;
instruction means for providing an intelligent software agent executing within one of said plurality of client computer systems; and
instruction means for searching, utilizing said intelligent agent, said plurality of client computer systems for said plurality of available items which match one of said plurality of types of items.

25. The product according to claim 20, wherein said instruction means for ranking further comprises instruction means for comparing a price for each of said plurality of available items to a utility for one of said plurality of types of items which matches said each of said plurality of available items.

26. The product according to claim 25, wherein said instruction means for comparing further comprises instruction means for determining a difference between said price for each of said plurality of available items and said utility for one of said plurality of types of items which matches said each of said plurality of available items.

27. The product according to claim 25, wherein said instruction means for comparing further comprises instruction means for determining a ratio of said price for each of said plurality of available items to said utility for one of said plurality of types of items which matches said each of said plurality of available items.

28. The product according to claim 20, further comprising:
instruction means for setting a utility threshold; and
instruction means for locating a second plurality of available items which match one of said plurality of types of items and which exceed said utility threshold.

29. The product according to claim 28, further comprising instruction means for selecting one of said second plurality of available items having a lowest price.

30. The product according to claim 20, further comprising instruction means for displaying said located plurality of available items.

31. The product according to claim 20, further comprising instruction means for selecting one of said located plurality of available items.

32. The product according to claim 20, further comprising:
instruction means for selecting, utilizing an intelligent agent, one of said located plurality of available items; and
instruction means for completing a purchase transaction, utilizing said intelligent agent, to purchase said selected one of said located plurality of items.

33. The product according to claim 32, further comprising instruction means for determining a ratio of a price for each of said plurality of available items to said utility for one of said plurality of types of items which matches said each of said plurality of available items.

34. The product according to claim 33, further comprising instruction means for selecting one of said located plurality of available items which provides a highest ratio.

35. The product according to claim 20, further comprising instruction means for receiving said plurality of types of items specified by a user.

36. The product according to claim 20, further comprising instruction means for receiving said plurality of types of items specified by executing a table lookup.

37. The product according to claim 20, further comprising instruction means for receiving said utility for each of said plurality of types of items specified by a user.

38. The product according to claim 20, further comprising:
instruction means for receiving a plurality of attributes for each of said specified plurality of types of items;
instruction means for receiving a weighting value specified for each of said plurality of attributes; and
instruction means for determining an overall utility for each of said plurality of types of items utilizing said weighting value specified for each of said plurality of attributes.

39. A computer system comprising:
said computer system for receiving a general requirement;
said computer system for receiving a specified utility for at least one of a plurality of types of items which would satisfy said requirement;
said computer system including a CPU executing code for locating a plurality of available items which match at least one of said plurality of types of items; and
said CPU executing code for ranking said located plurality of available items utilizing said utility specified for at least one of said plurality of types of items.

40. The system according to claim 39, further comprising:
an intelligent software agent;
said intelligent software agent for receiving a general requirement;
said intelligent software agent for a specified utility for each of a plurality of types of items which would satisfy said requirement;
said intelligent software agent for locating a plurality of available items which match one of said plurality of types of items; and
said intelligent software agent for ranking said located plurality of available items utilizing said utility specified for each of said plurality of types of items.

41. The system according to claim 40, further comprising said intelligent software agent executing within a client computer system, said client computer system being coupled to a server computer utilizing a computer network.

42. The system according to claim 41, further comprising said client computer system being coupled to said server computer system utilizing an Internet computer network.

43. The system according to claim 39, further comprising:
a server computer system coupled to a plurality of client computer systems;
an intelligent software agent executing within one of said plurality of client computer systems; and
said intelligent agent for searching said plurality of client computer systems for said plurality of available items which match one of said plurality of types of items.

44. The system according to claim 39, further comprising said CPU executing code for comparing a price for each of said plurality of available items to a utility for one of said plurality of types of items which matches said each of said plurality of available items.

45. The system according to claim 44, further comprising said CPU executing code for determining a difference between said price for each of said plurality of available items and said utility for one of said plurality of types of items which matches said each of said plurality of available items.

46. The system according to claim 44, further comprising said CPU executing code for determining a ratio of said price for each of said plurality of available items to said utility for one of said plurality of types of items which matches said each of said plurality of available items.

47. The system according to claim 39, further comprising:
a utility threshold; and
said CPU executing code for locating a second plurality of available items which match one of said plurality of types of items and which exceed said utility threshold.

48. The system according to claim 47, further comprising said CPU executing code for selecting one of said second plurality of available items having a lowest price.

49. The system according to claim 39, further comprising said CPU executing code for displaying said located plurality of available items.

50. The system according to claim 39, further comprising said CPU executing code for selecting one of said located plurality of available items.

51. The system according to claim 39, further comprising:
an intelligent agent for selecting one of said located plurality of available items; and
said intelligent agent for completing a purchase transaction to purchase said selected one of said located plurality of items.

52. The system according to claim 51, further comprising said CPU executing code for determining a ratio of a price for each of said plurality of available items to said utility for one of said plurality of types of items which matches said each of said plurality of available items.

53. The system according to claim 52, further comprising said CPU executing code for selecting one of said located plurality of available items which provides a highest ratio.

54. The system according to claim 39, further comprising said CPU executing code for receiving said plurality of types of items specified by a user.

55. The system according to claim 39, further comprising said CPU executing code for receiving said plurality of types of items specified by executing a table lookup.

56. The system according to claim 39, further comprising said CPU executing code for receiving said utility for each of said plurality of types of items specified by a user.

57. The system according to claim 39, further comprising:
said CPU executing code for receiving a plurality of attributes for each of said specified plurality of types of items;
said CPU executing code for receiving a weighting value specified for each of said plurality of attributes; and
said CPU executing code for determining an overall utility for each of said plurality of types of items utilizing said weighting value specified for each of said plurality of attributes.
